(19) United States
(12) Patent Application Publication
(10) Pub. No.: US 2007/0118726 A1
(43) Pub. Date: May 24, 2007

(54) System and method for dynamically selecting storage instruction performance scheme

(75) Inventors: Christopher Michael Abernathy, Austin, TX (US); Jonathan James DeMent, Austin, TX (US); David Shippy, Austin, TX (US); Albert James Van Nordstrand JR., Round Rock, TX (US)

Correspondence Address: IBM CORPORATION- AUSTIN (JVL);C/O VAN LEEUWEN & VAN LEEUWEN, PO BOX 90609, AUSTIN, TX, 78709-0609, US

(73) Assignee: International Business Machines Corporation

(21) Appl. No.: 11/284,681

(22) Filed: Nov. 22, 2005

(51) Int. Cl. G06F 9/44; G06F 13/28

(52) U.S. Cl. 712/225; 711/135

(57) ABSTRACT

A system and method for dynamic switching between performance schemes is presented. The software program uses an instruction to indicate whether a pacing performance scheme or a flushing performance scheme is to be used. The selection by the software program is stored in a hardware register that the processor uses to determine whether the pacing or flushing performance scheme is used. After setting the performance scheme, subsequent instructions of the software program will be executed using the selected performance scheme. The pacing performance scheme preemptively stalls an instruction that might overload the queue that stores instructions for the Load/Store Unit (LSU). The flushing performance scheme flushes instructions when the LSU storage queue is overloaded and holds the thread that caused the overflow dormant until the queue is no longer full.

### BACKGROUND OF THE INVENTION

1. Technical Field

The present invention relates in general to a system and method for dynamically selecting a storage instruction performance scheme. More particularly, the present invention relates to a system and method that allows software to set a hardware-based performance scheme used when processing storage instructions.

2. Description of the Related Art

An essential execution unit in many modern processors is the Load/Store Unit (LSU). As the name implies, the LSU handles storage instructions that include Loads and Stores which transfer data between the processor architected registers and the data caches and/or system memory. Modern processors are challenged by the number of Load instructions that can miss the primary cache and be queued while waiting for data to return. Similarly, modern processors are also challenged by the number of Store instructions that can be outstanding (waiting for results to be written to the cache) at any one time. Once the limit (number of Loads and/or number of Stores) is reached, the processor needs to handle the overflow.

In traditional processors, the processor is designed, or preset, to handle the overflow using a particular scheme. A challenge of using one particular scheme to handle the overflow is that the scheme may be beneficial to some types of code and detrimental to others. For example, the performance scheme may be beneficial to single-threaded code or to code that issues numerous storage instructions. However, this same performance scheme may be detrimental to multi-threaded code or code that issues fewer storage instructions. Likewise, another scheme may be beneficial to multi-threaded code but detrimental to single-threaded code or to code that issues numerous storage instructions.

What is needed, therefore, is a system and method that allows dynamic switching between performance schemes. What is further needed is a system and method that allows a software program to request a particular performance scheme and for the processor to use the requested performance scheme when executing the software program's instructions.

### SUMMARY

It has been discovered that the aforementioned challenges are resolved using a system and method that allows dynamic switching between performance schemes. The system and method allows a software program to request a particular performance scheme and for the processor to use the requested performance scheme when executing the software program's instructions.

The software program uses an instruction to indicate whether a pacing performance scheme or a flushing performance scheme is to be used. The selection by the software program is stored in a hardware register that the processor uses to determine whether the pacing or flushing performance scheme is used. After setting the performance scheme, subsequent instructions of the software program will be executed using the selected performance scheme.

When the pacing performance scheme is used, an instruction that might overload the queue that stores instructions for the Load/Store Unit (LSU) is preemptively stalled. The preemptive stall eliminates the flush penalty found with the flushing performance scheme. In a dual-thread system, where code for two threads is fetched and dispatched at the same time, a preemptive stall prevents instructions for either thread from issuing. Therefore, the pacing performance scheme is often more beneficial to single-threaded code or when both threads (in multi-threaded code) are issuing numerous storage instructions to be processed by the LSU.

On the other hand, when the flushing performance scheme is used, an instruction that overloads the queue causes a flush to be initiated. The flush causes all instructions to be flushed for the thread that issued the instruction that caused the overload. The thread that issued the instruction that caused the overload is also kept dormant until the queue is no longer full. By only holding this thread dormant, other threads can continue to issue instructions until they attempt a storage instruction. Because other threads can continue to execute, the flushing performance scheme is often more beneficial to multi-threaded code.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a high level diagram showing the interaction between the software code and the hardware in selecting a performance scheme;

FIG. 2 is a flowchart showing the steps taken to prepare software that utilizes dynamic performance scheme selection;

FIG. 3 is a flowchart showing the steps taken in executing software utilizing dynamic performance scheme selection;

FIG. 4 is a diagram showing how instructions are handled using the pacing performance scheme;

FIG. 5 is a diagram showing how instructions are handled using the flushing performance scheme;

FIG. 6 is a block diagram of a computing device capable of implementing the present invention; and

FIG. 7 is a block diagram of a broadband engine that includes a plurality of heterogeneous processors in which the present invention can be implemented.

### DETAILED DESCRIPTION

The following is intended to provide a detailed description of an example of the invention and should not be taken to be limiting of the invention itself. Rather, any number of variations may fall within the scope of the invention, which is defined in the claims following the description.

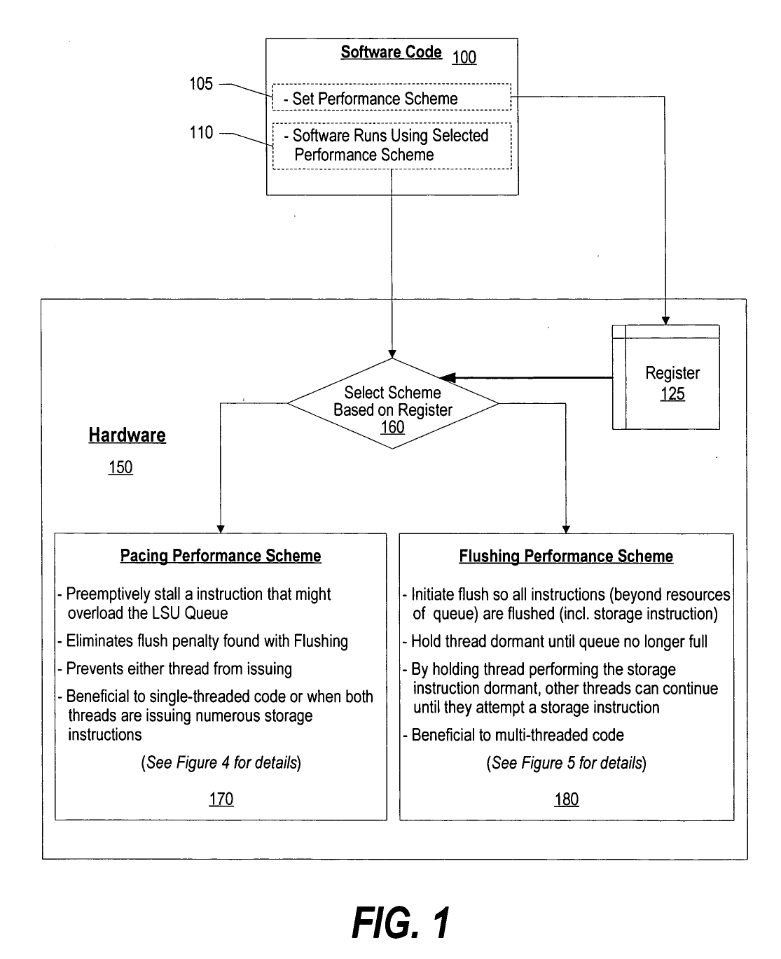

FIG. 1 is a high level diagram showing the interaction between the software code and the hardware in selecting a performance scheme. Software code 100 includes numerous instructions. Instruction 105 sets a performance scheme that is used by hardware 150. When instruction 105 is executed, data is recorded in one or more bits of hardware register 125 indicating the performance scheme to be used by hardware 150. Software instructions 110 are then executed using the selected performance scheme.

Hardware 150 selects a performance scheme (160) based on the performance scheme setting stored in hardware register 125. One setting causes instructions to be executed using pacing performance scheme 170 and another setting causes instructions to be executed using flushing performance scheme 180.

Pacing performance scheme 170 preemptively stalls an instruction that might overload the queue that stores instructions for the Load/Store Unit (LSU). The preemptive stall eliminates the flush penalty found with the flushing performance scheme. In a dual-thread system, where code for two threads is fetched and dispatched at the same time, a preemptive stall prevents instructions for either thread from issuing. Therefore, the pacing performance scheme is often more beneficial to single-threaded code or when both threads (in multi-threaded code) are issuing numerous storage instructions to be processed by the LSU. As will be apparent to those of skill in the art having benefit of the teachings herein, the pacing and flushing performance schemes can be used in single-threaded environments or multi-threaded environments where two or more threads are fetched, dispatched, and issued.

Flushing performance scheme 180 flushes a thread that issues a storage instruction when the LSU queue is already full. The flush causes all instructions to be flushed for the thread that issued the instruction that caused the overload. The thread that issued the instruction that caused the overload is also kept dormant until the queue is no longer full. By only holding this thread dormant, other threads can continue to issue instructions until they attempt a storage instruction. Because other threads can continue to execute, the flushing performance scheme is often more beneficial to multi-threaded code.

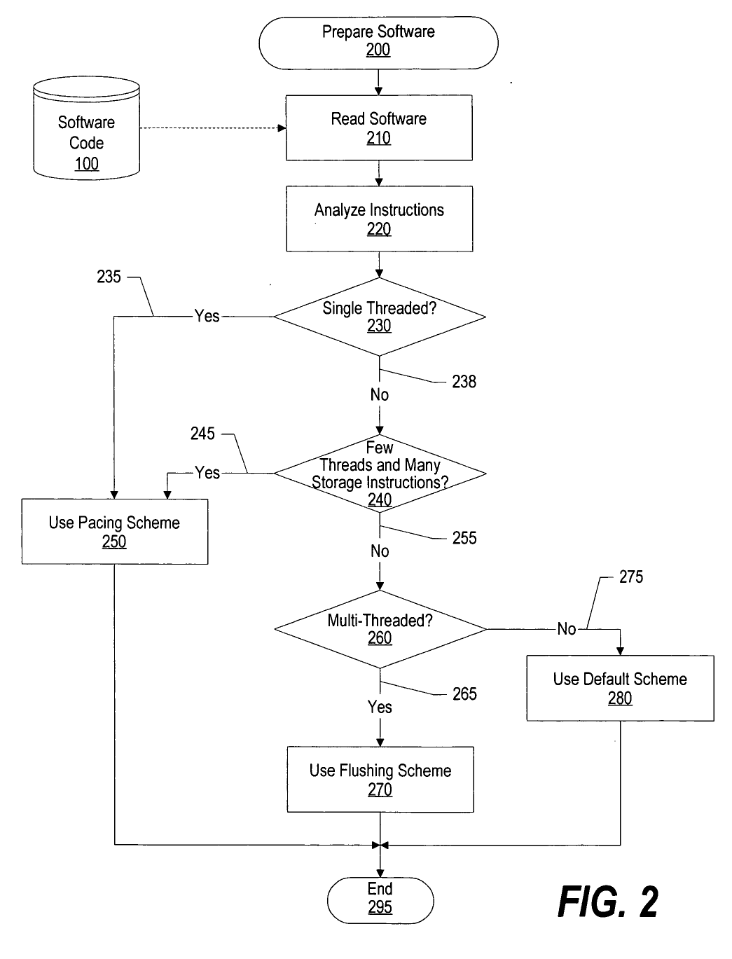

FIG. 2 is a flowchart showing the steps taken to prepare software that utilizes dynamic performance scheme selection. The preparation steps shown in FIG. 2 can be performed manually (i.e., by a programmer), or can be performed automatically (i.e., by a compiler that is compiling software).

Processing commences at 200 whereupon, at step 210, software code 100 is read. At step 220, the instructions included in software code 100 are analyzed. Following the analysis, determinations are made as to whether the code is better suited for the pacing performance scheme or the flushing performance scheme. First, a determination is made as to whether the code is primarily, or exclusively, single-threaded code (decision 230). If the code is mostly single-threaded, decision 230 branches to “yes” branch 235 whereupon, at step 250, an instruction is added towards the beginning of the software code instructions to request the pacing performance scheme, as this scheme is better suited to single-threaded code.

On the other hand, if the code is not single threaded, decision 230 branches to “no” branch 238 whereupon a determination is made as to whether there are few threads and many storage instructions (decision 240). If there are few threads and many storage instructions, decision 240 branches to “yes” branch 245 whereupon, at step 250, an instruction is added towards the beginning of the software code instructions to request the pacing performance scheme, as this scheme is better suited to code with few threads and many storage instructions.

Returning to decision 240, if there are either many threads or few (not many) storage instructions, decision 240 branches to “no” branch 255 whereupon a determination is made as to whether the code is multi-threaded (i.e., has many threads, decision 260). If the code is multi-threaded, decision 260 branches to “yes” branch 265 whereupon, at step 270 an instruction is added towards the beginning of the software code instructions to request the flushing performance scheme, as this scheme is better suited to multi-threaded code. On the other hand, if the code is not multi-threaded, decision 260 branches to “no” branch 275 whereupon, at step 280, a default performance scheme is used (either the pacing performance scheme or the flushing performance scheme). The default scheme may be chosen by software or may simply be whatever performance scheme is currently in use by the processor. After a performance scheme has been selected for the code, processing ends at 295. A single program can serially use multiple performance schemes by requesting one scheme at one point in the code and the other scheme at a different point in the code.

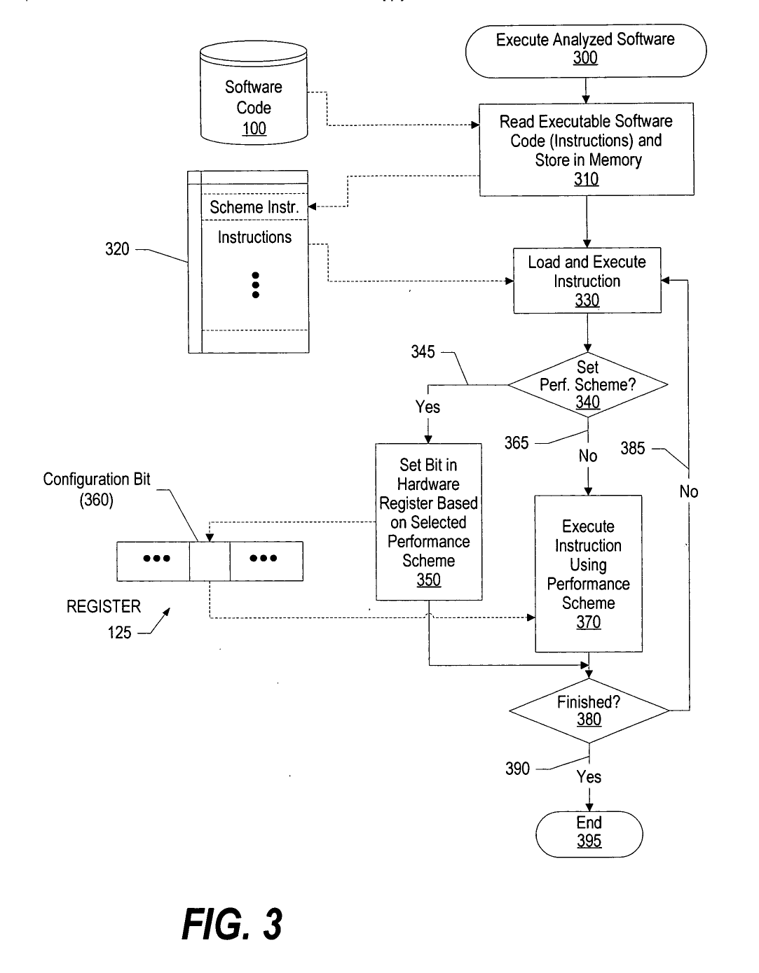

FIG. 3 is a flowchart showing the steps taken in executing software utilizing dynamic performance scheme selection. Processing commences at 300 whereupon, at step 310 software code 100 is read and stored in memory 320.

At step 330, the first instruction is loaded from memory 320 and executed by the processor. A determination is made as to whether the instruction is to set the performance scheme (decision 340). If the instruction sets the performance scheme, decision 340 branches to “yes” branch 345 whereupon, at step 350 bit (360) in hardware register 125 is set according to the performance scheme being requested by the instruction (e.g., a “0” for the pacing performance scheme and a “1” for the flushing performance scheme). On the other hand, if the instruction does not set the performance scheme, decision 340 branches to “no” branch 365 whereupon, at step 370, the hardware executes the instruction. If the instruction is a storage instruction (i.e., a load or a store instruction), then the performance scheme identified in hardware register 125 is used to handle an LSU queue overflow condition. Instructions continue to execute using the performance scheme that was last set (stored in hardware register 125). A determination is made as to whether the code is finished executing (decision 380). If there is more code to execute, decision 380 branches to “no” branch 385 which loops back to load and execute the next instruction. This continues until the software code is finished executed, at which time decision 380 branches to “yes” branch 390 and processing ends at 395.

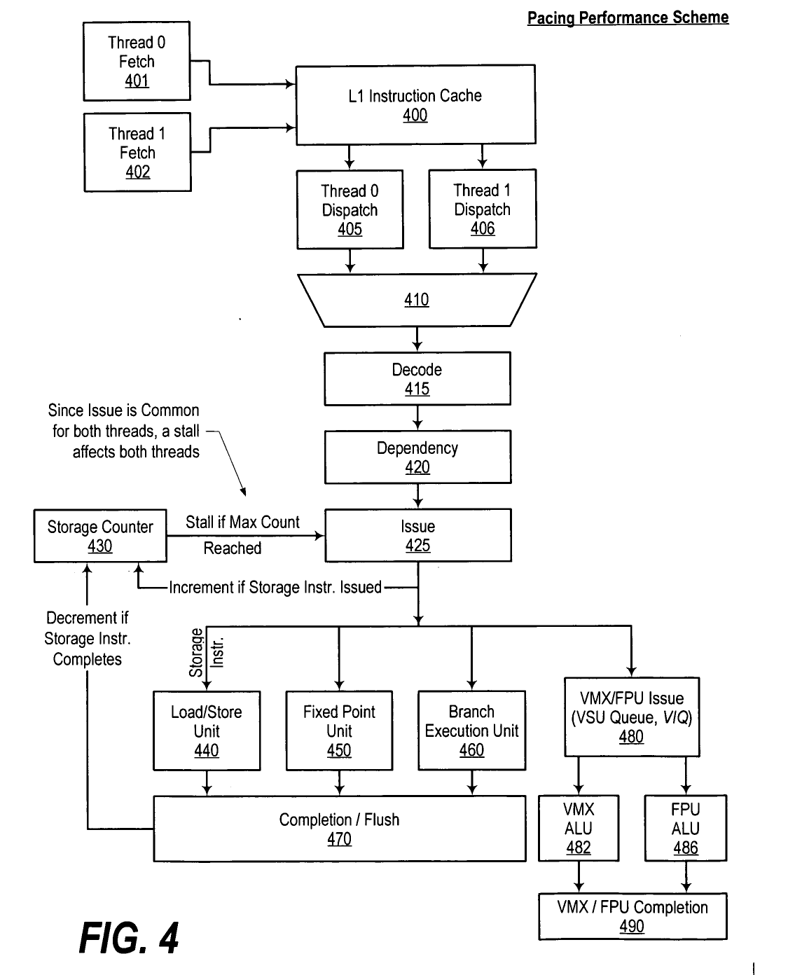

FIG. 4 is a diagram showing how instructions are handled using the pacing performance scheme. Level One (L1) cache 400 is memory that is very high speed but small in size. The processor tries to read instructions from level one cache 400 first. If the required instruction is not present in the L1 cache, the L2 cache (not shown) is tried next. L2 cache is a larger size but slower speed than the L1 cache. If the required instruction is not present in the L2 cache, the system memory (DRAM) or L3 cache if there is one, is tried next. The slower the cache, the longer the wait for the needed instruction.

Fetch circuitry is used to fetch needed instructions from L1 cache 400 or other memory areas, such as the L2 cache. In a dual-thread system, there is fetch circuitry 401 to fetch a first thread (Thread 0), and fetch circuitry 402 to fetch a second thread (Thread 1). In addition, the Fetch circuitry retrieves predicted instruction information from branch scanning (not shown). In the embodiment shown, there are two instruction buffer stages for two threads. In one embodiment, the instruction buffer is a FIFO queue which is used to buffer up to four instructions fetched from the L1 ICache for each thread when there is a downstream stall condition. An Instruction buffer stage is used to load the instruction buffers, one set of instruction buffers for each thread. Another instruction buffer stage is used to unload the instruction buffer and multiplex (mux) down to two instructions (Dispatch 410). In one embodiment, each thread is given equal priority in dispatch, toggling every other cycle. Dispatch also controls the flow of instructions to and from microcode, which is used to break an instruction that is difficult to execute into multiple “micro-ops” (not shown). In the embodiment shown, the first thread (Thread 0) dispatches using dispatch circuitry 405 and the second thread (Thread 1) dispatches using dispatch circuitry 406. The results from dispatch circuitry 405, 406, and the microcode are multiplexed (Mux 410) together to provide an instruction (or multiple instructions in a multi-issue design) to decode logic 415.

Decode circuitry 415 is used to assemble the instruction internal opcodes and register source/target fields. In addition, dependency checking 420 starts in one stage of the decoder and checks for data hazards (read-after-write, write-after-write, etc.).

Issue logic 425 continues in various pipeline stages to create a single stall point which is propagated up the pipeline to the instruction buffers, stalling both threads. The stall point is driven by data-hazard detection, in addition to resource-conflict detections, among other conditions including if the load counter 430 has reached its maximum value. Issue logic 425 determines the appropriate routing of the instructions, upon which they are issued to the execution units. In one embodiment, each instruction can be routed to five different issue slots: Load/Store Unit (LSU) 440, fixed-point unit 450, branch unit 460, and two to the VSU issue queue slots 480, also known as the VMX/FPU Issue Queue as this queue handles VMX (VMX ALU 482) and floating-point instructions (FPU ALU 486). Instructions processed by LSU 440, fixed-point unit 450, or branch unit 460, complete (either a completion or a flush) at completion/flush 470. Likewise, instructions processed by VMX ALU 482 or FPU ALU 486 complete at completion 490.

When the pacing performance scheme is used, load counter 430 is used to keep track of the number of storage instructions being processed by LSU 440. When issue circuitry 425 issues an instruction to LSU 440, storage counter 430 is incremented. Likewise, when a storage instruction completes at completion 490, storage counter 430 is decremented. When the storage counter reaches a certain threshold (i.e., the maximum number of storage instructions that can be queued for LSU 440), issue circuitry 425 is stalled, preventing additional instructions from either thread (Thread 0 or Thread 1) to be issued. The stall is maintained until one or more storage instructions are completed by LSU 440 (causing storage counter 430 to decrement to a value below the threshold).

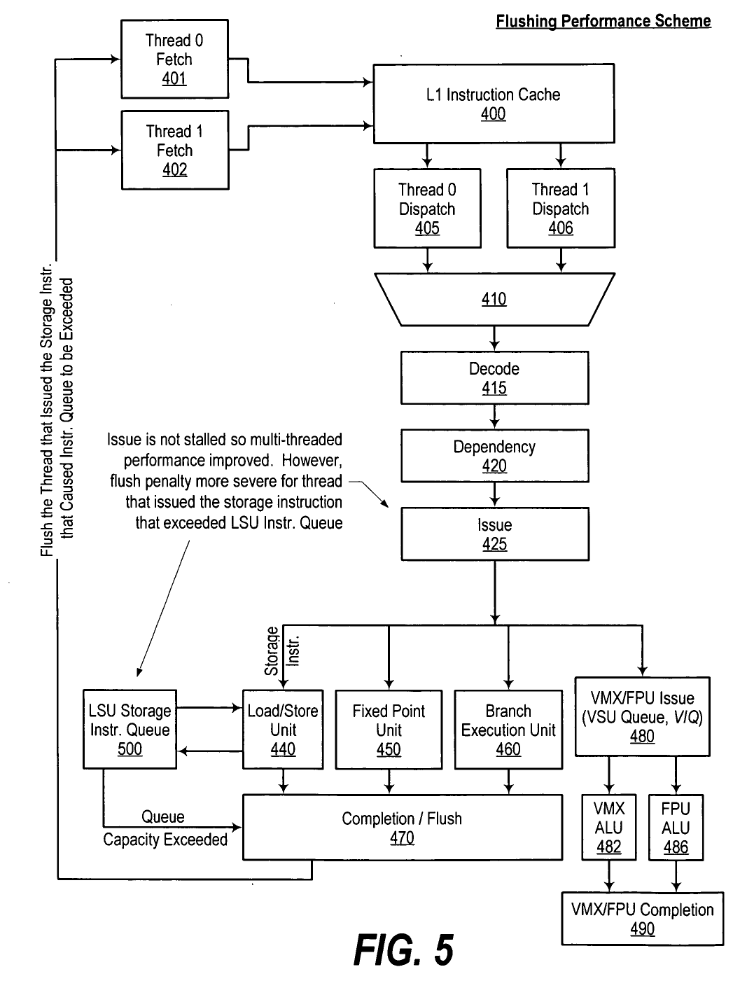

FIG. 5 is a diagram showing how instructions are handled using the flushing performance scheme. The execution units used in the flushing performance scheme are largely the same as those used in the pacing performance scheme depicted in FIG. 4. However, in the flushing performance scheme shown in FIG. 5, a counter is not used to keep track of the number of storage instructions queued to LSU 440. Accordingly, the flushing performance scheme does not cause issue 425 to stall because of the counter since the counter is not being used.

Instead, when the flushing performance scheme is used, issue 425 continues to issue storage instructions to LSU 440 regardless of the number of storage instructions already in the LSU's queue (LSU Storage Instruction Queue 500). If queue 500 is full and issue 425 issues another storage instruction to LSU 440, the queue capacity is exceeded, causing a flush condition. The flush condition flushes instructions for the thread that caused queue 500 to be exceeded. In addition, the thread that caused the overflow is held dormant until queue 500 signals that it is no longer full. While one thread is flushed and held dormant, the other thread is able to continue executing until it issues a storage instruction (provided that queue 500 is still full). For example, if queue 500 is full and Thread 0 issues a storage instruction, the instructions issued for Thread 0 are flushed (including the storage instruction that caused the overflow). Meanwhile, Thread 1 can continue executing. Thread 1 does not get flushed and held dormant unless it also issues a storage instruction while queue 500 is still full.

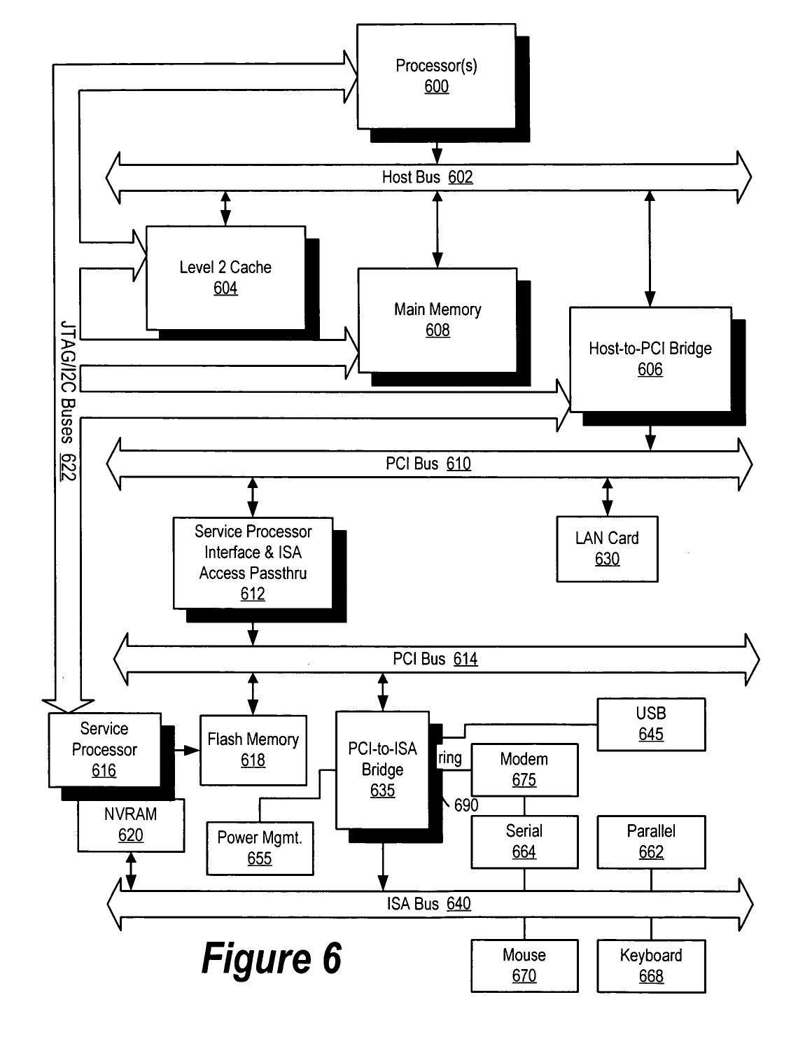

FIG. 6 illustrates an information handling system, which is a simplified example of a computer system capable of performing the computing operations described herein. Broadband processor architecture (BPA) 600 includes a plurality of heterogeneous processors, a common memory, and a common bus. The heterogeneous processors are processors with different instruction sets that share the common memory and the common bus. For example, one of the heterogeneous processors may be a digital signal processor and the other heterogeneous processor may be a microprocessor, both sharing the same memory space.

BPA 600 sends and receives information to/from external devices through input output 670, and distributes the information to control plane 610 and data plane 640 using processor element bus 660. Control plane 610 manages BPA 600 and distributes work to data plane 640.

Control plane 610 includes processing unit 620, which runs operating system (OS) 625. For example, processing unit 620 may be a Power PC core that is embedded in BPA 600 and OS 625 may be a Linux operating system. Processing unit 620 manages a common memory map table for BPA 600. The memory map table corresponds to memory locations included in BPA 600, such as L2 memory 630 as well as non-private memory included in data plane 640.

Data plane 640 includes Synergistic Processing Complex's (SPC) 645, 650, and 655. Each SPC is used to process data information and each SPC may have different instruction sets. For example, BPA 600 may be used in a wireless communications system and each SPC may be responsible for separate processing tasks, such as modulation, chip rate processing, encoding, and network interfacing. In another example, each SPC may have identical instruction sets and may be used in parallel to perform operations benefiting from parallel processes. Each SPC includes a synergistic processing unit (SPU). An SPU is preferably a single instruction, multiple data (SIMD) processor, such as a digital signal processor, a microcontroller, a microprocessor, or a combination of these cores. In a preferred embodiment, each SPU includes a local memory, registers, four floating-point units, and four integer units. However, depending upon the processing power required, a greater or lesser number of floating points units and integer units may be employed.

SPC 645, 650, and 655 are connected to processor element bus 660, which passes information between control plane 610, data plane 640, and input/output 670. Bus 660 is an on-chip coherent multi-processor bus that passes information between I/O 670, control plane 610, and data plane 640. Input/output 670 includes flexible input-output logic which dynamically assigns interface pins to input output controllers based upon peripheral devices that are connected to BPA 600.

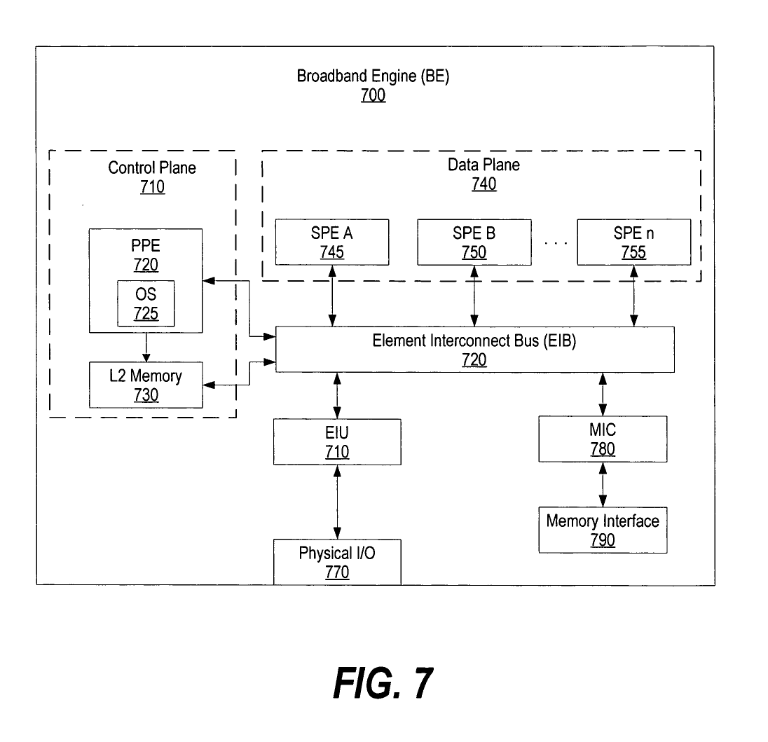

FIG. 7 illustrates information handling system 701 which is another simplified example of a computer system capable of performing the computing operations described herein. Information handling system 701 includes processor 700 which is coupled to host bus 702. A level two (L2) cache memory 704 is also coupled to host bus 702. Host-to-PCI bridge 706 is coupled to main memory 708, includes cache memory and main memory control functions, and provides bus control to handle transfers among PCI bus 710, processor 700, L2 cache 704, main memory 708, and host bus 702. Main memory 708 is coupled to Host-to-PCI bridge 706 as well as host bus 702. Devices used solely by host processor(s) 700, such as LAN card 730, are coupled to PCI bus 710. Service Processor Interface and ISA Access Pass-through 712 provides an interface between PCI bus 710 and PCI bus 714. In this manner, PCI bus 714 is insulated from PCI bus 710. Devices, such as flash memory 718, are coupled to PCI bus 714. In one implementation, flash memory 718 includes BIOS code that incorporates the necessary processor executable code for a variety of low-level system functions and system boot functions.

PCI bus 714 provides an interface for a variety of devices that are shared by host processor(s) 700 and Service Processor 716 including, for example, flash memory 718. PCI-to-ISA bridge 735 provides bus control to handle transfers between PCI bus 714 and ISA bus 740, universal serial bus (USB) functionality 745, power management functionality 755, and can include other functional elements not shown, such as a real-time clock (RTC), DMA control, interrupt support, and system management bus support. Nonvolatile RAM 720 is attached to ISA Bus 740. Service Processor 716 includes JTAG and I2C busses 722 for communication with processor(s) 700 during initialization steps. JTAG/I2C busses 722 are also coupled to L2 cache 704, Host-to-PCI bridge 706, and main memory 708 providing a communications path between the processor, the Service Processor, the L2 cache, the Host-to-PCI bridge, and the main memory. Service Processor 716 also has access to system power resources for powering down information handling system 701.

Peripheral devices and input/output (I/O) devices can be attached to various interfaces (e.g., parallel interface 762, serial interface 764, keyboard interface 768, and mouse interface 770 coupled to ISA bus 740. Alternatively, many I/O devices can be accommodated by a super I/O controller (not shown) attached to ISA bus 740.

In order to attach computer system 701 to another computer system to copy files over a network, LAN card 730 is coupled to PCI bus 710. Similarly, to connect computer system 701 to an ISP to connect to the Internet using a telephone line connection, modem 775 is connected to serial port 764 and PCI-to-ISA Bridge 735.

While the information handling systems described in FIGS. 6 and 7 are capable of executing the processes described herein, these computer systems are simply examples of computer systems. Those skilled in the art will appreciate that many other computer system designs are capable of performing the processes described herein, such as gaming systems, imaging systems, seismic computer systems, and animation systems.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A computer-implemented method comprising:
executing a plurality of instructions on a computer system;
identifying a performance scheme setting in one of the instructions;
setting a hardware-based performance scheme of the computer setting based on the performance scheme setting, wherein the performance scheme is selected from a plurality of available performance schemes, and wherein one of the available performance schemes is a flushing performance scheme and wherein one of the available performance schemes is a pacing performance scheme;
processing a plurality of storage instructions included in the plurality of instructions, wherein the plurality of storage instructions occur after the instruction that identified the performance scheme;
identifying that at least one of the storage instructions is beyond the resources of the computer system; and
handling the storage instructions that are beyond the resources of the computer system using a scheme indicated by the hardware-based performance scheme.

2. (canceled)

3. The method of claim 1 wherein the scheme indicated by the hardware-based storage instruction setting is the flushing performance scheme, the method further comprising:
issuing the storage instructions to an execution unit within a processor that is executing the instructions;
before being processed by the execution unit, storing a plurality of the issued storage instructions in a queue until the queue is full;
when the queue is full, issuing an additional storage instruction to the execution unit, wherein the additional storage instruction belongs to a thread; and
flushing the one or more instructions that belong to the thread, including the additional storage instruction.

4. The method of claim 1 wherein the scheme indicated by the hardware-based storage instruction setting is the pacing performance scheme, the method further comprising:
issuing the instructions to a plurality of execution units within a processor that is executing the instructions;
incrementing a counter each time one of the storage instructions is issued to one of the execution units selected from the plurality of execution units that handles storage instructions;
decrementing the counter each time the storage instruction-handling execution unit completes execution of one of the storage instructions; and
stalling the issuing of instructions when the counter reaches a threshold value.

5. The method of claim 1 further comprising:
issuing the storage instructions to a Load/Store Unit (LSU) included in a processor that is executing the instructions, and wherein the storage instructions include load instructions and store instructions.

6. The method of claim 1 wherein the handling of the storage instructions that are beyond the resources of the computer system further comprises:
in response to the scheme being the flushing performance scheme:
issuing the storage instructions to an execution unit within a processor that is executing the instructions;
before being processed by the execution unit, storing a plurality of the issued storage instructions in a queue until the queue is full;
when the queue is full, issuing an additional storage instruction to the execution unit, wherein the additional storage instruction belongs to a thread; and
flushing the one or more instructions that belong to the thread, including the additional storage instruction; and
in response to the scheme being the pacing performance scheme:
issuing the instructions to a plurality of execution units within a processor that is executing the instructions;
incrementing a counter each time one of the storage instructions is issued to one of the execution units selected from the plurality of execution units that handles storage instructions;
decrementing the counter each time the storage instruction-handling execution unit completes execution of one of the storage instructions; and
stalling the issuing of instructions when the counter reaches a threshold value.

7. The method of claim 1 wherein the hardware-based storage instruction setting is stored in one or more bits of a hardware register.

8. A processor comprising:
a plurality of execution units, where one of the execution units is a Load/Store Unit (LSU);
a software-settable hardware register with at least one bit that identifies a performance scheme to be used, wherein the performance scheme is selected from a plurality of available performance schemes, and wherein one of the available performance schemes is a flushing performance scheme and wherein one of the available performance schemes is a pacing performance scheme;
issue circuitry that issues a plurality of instructions to the execution units, wherein a plurality of the instructions are storage instructions that are issued to the LSU;
a queue that stores the storage instructions issued to the LSU; and
a plurality of queue limit circuitries, wherein each of the queue limit circuitries implements one of the performance schemes, and wherein one of the circuitries is selected based upon the bit that identifies the performance scheme.

9. (canceled)

10. The processor of claim 8 wherein the performance scheme indicated by the bit is the flushing performance scheme, the processor further comprising:
queue circuitry that, when the queue is full and another storage instruction for a thread is issued to the LSU by the issue circuitry, signals a flush of the one or more instructions that belong to the thread, including the additional storage instruction.

11. The processor of claim 10 wherein the processor is a multiple-thread processor, the processor further comprising:
fetch circuitry to fetch a first thread's instructions and a second thread's instructions;
dispatch circuitry to dispatch the fetched first thread's instructions and the fetched second thread's instructions, wherein the issue circuitry issues both the dispatched first thread's instructions and the dispatched second thread's instructions to the execution units; and
flush circuitry that receives the flush signal and flushes:
one or more instructions of the first thread in response to the additional storage instruction being one of the first thread's instructions; and
one or more instructions of the second thread in response to the additional storage instruction being one of the second thread's instructions.

12. The processor of claim 11 further comprising:
control circuitry that receives the flush signal and:
in response to the additional storage instruction being one of the first thread's instructions:
halts further execution of the first thread's instructions; and
continues further execution of the second thread's instructions; and
in response to the additional storage instruction being one of the second thread's instructions:
halts further execution of the second thread's instructions; and
continues further execution of the first thread's instructions.

13. The processor of claim 8 wherein the performance scheme indicated by the bit is the pacing performance scheme, the processor further comprising:
counter circuitry that increments a counter each time one of the storage instructions is issued to the LSU, decrements the counter each time the LSU completes execution of one of the storage instructions, and sends a stall signal to the issue circuitry when the counter reaches a threshold value.

14. The processor of claim 13 wherein the processor is a multiple-thread processor, the processor further comprising:
fetch circuitry to fetch a first thread's instructions and a second thread's instructions;
dispatch circuitry to dispatch the fetched first thread's instructions and the fetched second thread's instructions, wherein the issue circuitry issues both the dispatched first thread's instructions and the dispatched second thread's instructions to the execution units; and
stall logic used by the issue circuitry to stall both the first thread and the second thread when the stall signal is received by the issue circuitry.

15. A computer program product in a computer-readable medium comprising a plurality of instructions that, when executed by a computer, directs the computer to perform actions of:
set a hardware-based performance scheme of the computer setting based on a performance scheme setting in at least one of the instructions;
process a plurality of storage instructions included in the plurality of instructions, wherein the plurality of storage instructions occur after the instruction that identified the performance scheme, wherein the performance scheme is selected from a plurality of available performance schemes, and wherein one of the available performance schemes is a flushing performance scheme and wherein one of the available performance schemes is a pacing performance scheme;
identify that at least one of the storage instructions is beyond the resources of the computer system; and
handle the storage instructions that are beyond the resources of the computer system using a scheme indicated by the hardware-based performance scheme.

16. (canceled)

17. The program product of claim 15 wherein the scheme indicated by the hardware-based storage instruction setting is the flushing performance scheme, wherein the computer is further directed to perform the actions of:
issuing the storage instructions to an execution unit within a processor that is executing the instructions;
before being processed by the execution unit, storing a plurality of the issued storage instructions in a queue until the queue is full;
when the queue is full, issuing an additional storage instruction to the execution unit, wherein the additional storage instruction belongs to a thread; and
flushing the one or more instructions that belong to the thread, including the additional storage instruction.

18. The program product of claim 15 wherein the scheme indicated by the hardware-based storage instruction setting is the pacing performance scheme, wherein the computer is further directed to perform the actions of:
issuing the instructions to a plurality of execution units within a processor that is executing the instructions;
incrementing a counter each time one of the storage instructions is issued to one of the execution units selected from the plurality of execution units that handles storage instructions;
decrementing the counter each time the storage instruction-handling execution unit completes execution of one of the storage instructions; and
stalling the issuing when the counter reaches a threshold value.

19. The program product of claim 15, wherein the computer is further directed to perform the actions of:
issuing the storage instructions to a Load/Store Unit (LSU) included in a processor that is executing the instructions, and wherein the storage instructions include load instructions and store instructions.

20. The program product of claim 15 wherein the computer is further directed to perform the actions of:
handle the storage instructions that are beyond the resources of the computer system when the scheme is the flushing performance scheme by:
issuing the storage instructions to an execution unit within a processor that is executing the instructions;
before being processed by the execution unit, storing a plurality of the issued storage instructions in a queue until the queue is full;
when the queue is full, issuing an additional storage instruction to the execution unit, wherein the additional storage instruction belongs to a thread; and
flushing the one or more instructions that belong to the thread, including the additional storage instruction; and
handle the storage instructions that are beyond the resources of the computer system when the scheme is the pacing performance scheme by:
issuing the instructions to a plurality of execution units within a processor that is executing the instructions;
incrementing a counter each time one of the storage instructions is issued to one of the execution units selected from the plurality of execution units that handles storage instructions;
decrementing the counter each time the storage instruction-handling execution unit completes execution of one of the storage instructions; and
stalling the issuing when the counter reaches a threshold value.
